(19) United States
(12) Patent Application Publication
(10) Pub. No.: US 2010/0195064 A1
(43) Pub. Date: Aug. 5, 2010

(54) MOBILE DEVICE HAVING PROJECTOR MODULE AND DISPLAY METHOD FOR DATA PROJECTED ONTO EXTERNAL DISPLAY SCREEN FROM THE PROJECTOR MODULE

(75) Inventors: Bo Sung KIM, Gyeonggi-do (KR); Sung Bae KIM, Gyeonggi-do (KR); Tae Young KIM, Gyeonggi-do (KR); Phil Jun KIM, Gyeonggi-do (KR); Young Ho CHO, Seoul (KR); Young Il CHOI, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/698,254

(22) Filed: Feb. 2, 2010

(30) Foreign Application Priority Data
Feb. 5, 2009 (KR) 10-2009-0009492

(51) Int. Cl. G03B 21/14

(52) U.S. Cl. 353/121; 353/122

(57) ABSTRACT

A mobile device has a projector module which projects data onto an external display screen. A method for displaying data in the mobile device includes activating the projector module and detecting output property information in at least one of content and an application. The method further includes determining a display format of output data of the content or the application based on the detected output property information. Also, the method includes projecting the output data in the determined display format through the activated projector module in a horizontal or vertical orientation. Such a display format may be changed according to a user's preference or a device presetting environment.

### CLAIMS OF PRIORITY

This application claims the benefit of priority to an earlier application entitled “MOBILE DEVICE HAVING PROJECTOR MODULE AND DISPLAY METHOD FOR DATA PROJECTED ONTO EXTERNAL DISPLAY SCREEN FROM THE PROJECTOR MODULE”, filed in the Korean Intellectual Property Office on Feb. 5, 2009 and assigned Serial No. 10-2009-0009492, the contents of which are incorporated herein by reference.

### BACKGROUND OF THE INVENTION

1. Field of the Invention

The present invention relates in general to a mobile device having a projector module and, more particularly, to a scheme of displaying data onto an external display screen while automatically regulating a display format of the projected data according to the output properties of contents or applications executed in the mobile device.

2. Description of the Related Art

A variety of mobile devices have been developed in recent years. A rapid advance in mobile communication technologies provided traditional mobile devices with even more useful applications. As a result, mobile users can now send various forms of voice, text, and graphic data as well as other music and game entertainment.

However, mobile devices have inherent limitations in size which restrict the ability to representing output data. Therefore, these days a projector module is introduced to magnify the output data, such as a still image or a moving image, onto an external display screen.

However, a mobile device equipped with a projector module was introduced recently. Hence such a mobile device lacks functions that are made available for user's convenience. Accordingly, there is a need to provide a mobile device having a projector module that meets user's demands and convenience.

### BRIEF SUMMARY OF THE INVENTION

Accordingly, an aspect of the present invention is to address the above-mentioned problems and/or disadvantages and to provide at least the advantages described below.

Aspects of the present invention are to provide a mobile device having a projector module and a method for displaying data projected onto an external display screen from the projector module while automatically regulating a display format of the projected data according to the output properties of contents or applications executed in the mobile device, without requiring a user's additional manipulation.

According to one aspect of the present invention, provided is a method for displaying data in a mobile device having a projector module, the method comprising: activating the projector module; detecting output property information in at least one of content and an application; determining a display format of output data of the content or the application depending on the detected output property information; and projecting the output data in the determined display format through the activated projector module.

According to another aspect of the present invention, a mobile device includes: a memory unit configured to store at least one content or at least one application; a display unit configured to display output data related to the execution of the content or the application stored in the memory unit; a control unit configured to detect output property information in at least one of the content and the application, and to determine a display format of the output data of the content or the application depending on the detected output property information; and a projector module configured to project the output data in the determined display format under the control of the control unit.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a block diagram which illustrates a configuration of a mobile device having a projector module in accordance with an exemplary embodiment of the present invention.

FIG. 2 is a block diagram which illustrates a configuration of a control unit shown in FIG. 1.

FIG. 3 is an example view which illustrates a display image projected onto an external display screen from a projector module in accordance with an exemplary embodiment of the present invention.

FIG. 4 is an example view which illustrates a display image projected onto an external display screen from a projector module in accordance with another exemplary embodiment of the present invention.

FIG. 5 is a flow diagram which illustrates a display method for data projected onto an external display screen from a projector module in accordance with an exemplary embodiment of the present invention.

### DETAILED DESCRIPTION OF THE INVENTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail for simplicity and to avoid obscuring the essence of the present invention. Although the drawings represent exemplary embodiments of the invention, the drawings are not necessarily to scale and certain features may be exaggerated or omitted in order to better illustrate and explain the present invention.

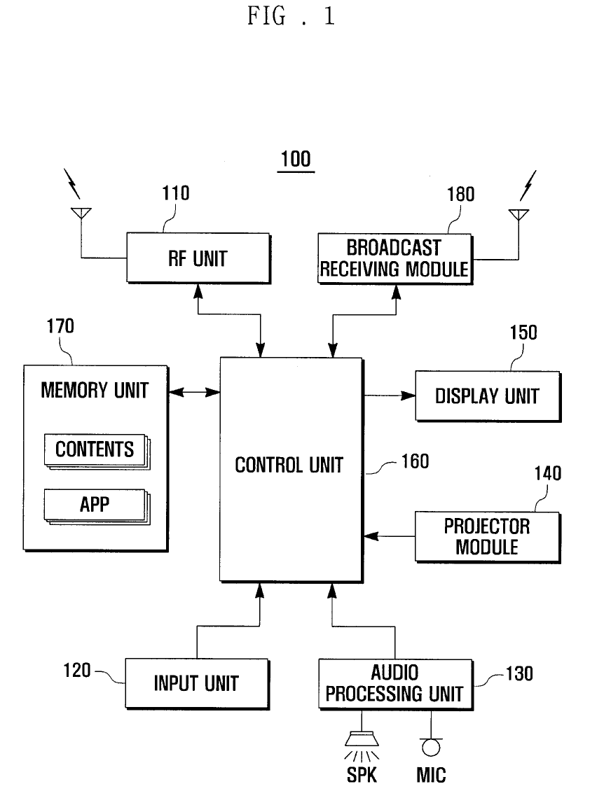

FIG. 1 is a block diagram which illustrates a configuration of a mobile device having a projector module in accordance with an exemplary embodiment of the present invention.

Referring to FIG. 1, the mobile device 100 includes a radio frequency (RF) unit 110, an input unit 120, an audio processing unit 130, a projector module 140, a display unit 150, a memory unit 170, a broadcast receiving module 180, and a control unit 160.

The mobile device 100 having the above listed configuration regulates a display format of data outputted from the projector module 140 and projects such output data onto an external display screen automatically during various function modes, such as a file search function, a voice call function, a broadcast receiving function, a file play function, and so forth. That is, the mobile device 100 is capable of adjusting a display format, such as a display direction (hereinafter often referred to as a display mode) and a display size (hereinafter often referred to as a display ratio), of output data which is projected onto the external display screen, regardless of a display format of data displayed on the display unit 150.

In operation, the RF unit 110 establishes necessary communication channels under the control of the control unit 160. That is, the RF unit 110 forms a voice call channel, a data communication channel, and a video call channel with a mobile communication system. The RF unit 110 may include an RF transmitter that upwardly converts the frequency of signals to be transmitted and amplifies the signals, and an RF receiver that amplifies received signals with low-noise and downwardly converts the frequency of the received signals.

The data transmission channel established by the RF unit 110 may be temporarily formed to perform a specific message service. This message delivered through the data transmission channel may be a short message, a multimedia message, an instant message, an e-mail, etc.

Particularly, the RF unit 110 of this invention may form the video call channel and output a received image of a video call through at least one of the display unit 150 and the projector module 140 under the control of the control unit 160.

The input unit 120 includes a plurality of input keys and function keys which are provided to receive a user's input. Here, the function keys may have navigation keys, side keys, shortcut keys, and any other special keys known those skilled in the art. The input unit 120 creates various key signals in association with user's selection or commands and delivers them to the control unit 160. Specifically, the input unit 120 may create input signals for selecting at least one of contents and applications stored in the memory unit 170, input signals for activating the projector module 140, and input signals for controlling the projector module 140, and then send them to the control unit 160.

The audio processing unit 130 comprises a speaker (SPK) for outputting audio signals and a microphone (MIC) for receiving audio signals. Particularly, when at least one of contents and applications stored in the memory unit 170 is activated, the audio processing unit 130 of this invention may output audio signals stored in contents or created by the activation of applications through the speaker (SPK). In addition, while visible data of contents or applications is being outputted through the projector module 140, the audio processing unit 130 may output audible data.

The projector module 140 outputs a variety of data to the external display screen. Specifically, the projector module 140 may output contents stored in the memory unit 170, data received through the execution of particular functions such as a digital broadcasting application, data received from various external electronic devices such as PC, TV, VCR, DVD or camcorder, and data generated during the execution of specific applications. Also, the projector module 140 may project graphical elements such as a mouse pointer onto the external display screen under the control of the control unit 160.

The projector module 140 generally includes: an image input part, a lens, a focus driving motor, a projection angle driving motor, and a projection angle sensor. The image input part receives data from the control unit 160, and the lens projects the received data onto any type of object such as a display screen. The focus driving motor regulates the focus of the lens on the display screen. The projection angle driving motor regulates the projection angle of data to be projected, and the projection angle sensor detects a projection angle and forwards the detected angle information to the control unit 160.

The display unit 150 represents a variety of information inputted by a user or offered to a user, such as various menus of the mobile device 100. That is, the display unit 150 may provide many display pages, visual images, or graphical elements in association with the use of the mobile device 100, including an idle page with a static or dynamic background image, a menu page with several depths, a message input page, a call execution image, and any others related to the execution of contents or applications. Particularly, the display unit 150 of this invention may change a display format of output data according to the output properties of contents or applications to be displayed. This will be described in detail hereinafter.

Normally the display unit 150 may be formed of a liquid crystal display (LCD), an organic light emitting device (OLED), or any other equivalents. Also, the display unit 150 may be fabricated in a touch-based form such as a touch screen which has an input function in addition to a display function. For example, the display unit 150 may have a display panel and touch sensors disposed on the display panel. If a touch screen is available, the mobile device 100 may provide various touch-based menu pages on the touch screen and may often offer a full screen image according to a user's setting environment.

The memory unit 170 stores a variety of applications required for the operation of the mobile device 100. Additionally, the memory unit 170 stores specific applications used for the execution of contents, and a key map or a menu map used for the operation of the touch screen. Here, the key map may have various well known types such as a keyboard map, a 3*4 key map, a qwerty key map, or a special control key map suitable for the operation of a specific application in use. Also, the menu map may have several menu items offered by the mobile device and may be a special menu map suitable for the operation of a specific application in use. The memory unit 170 may consist of a program region and a data region.

The program region stores an operating system (OS) for booting the mobile device 100, and applications used for the execution of various files or functions. Such applications may have an application for supporting a voice call or a video call, a web browser for access to the Internet server, an MP3 application for playing music, an image viewing application, a video playing application, a document editing application, etc.

Generally each individual application has information about its output properties required when displayed on the display unit 150. Such output property information refers to information which defines a display direction, a display size, etc. on the display unit 150 when each application is activated. In a case of a display direction, for example, a menu application may be defined to be outputted in a lengthwise mode on the display unit 150. Alternatively, a camera application or an application for supporting the broadcast receiving module 180 may be defined to be outputted in a widthwise mode on the display unit 150.

Output property information includes information about respective modes and information about size adjustment. This allows a mode switch between a lengthwise orientation and a widthwise orientation, depending on a selection signal from the input unit 120. That is, when some application is activated, a user of the mobile device 100 can find which mode is predefined as default of a display direction, and can change the display direction of output data from a lengthwise mode to a widthwise mode or vice versa using the input unit 120. Additionally, a user can change the display size of output data by using the input unit 120.

Also, the program region may store a projector control application which makes regulations on a display format, namely, a display direction and a display size, of data to be outputted through the projector module 140, depending on predefined values of output properties in contents or applications stored in the memory unit 170. The projector control application is loaded in the control unit 160 according to a selection signal from the input unit 120, and controls the display of data in association with content or application outputted through the projector module 140. This will be described later in connection with the control unit 160.

The data region stores data created while the mobile device 100 is used. In particular, the data region may store a great variety of contents. Also, the data region may store user's input received through a touch screen when the display unit 150 is formed of the touch screen. Generally respective contents may store information about output properties.

Output property information in contents includes the display direction, i.e., a lengthwise mode or a widthwise mode, of contents represented on the display unit 150. Although some contents have the same file extensions, they may be outputted in different display directions on the display unit 150 according to their output properties. In addition, output property information in contents may include the display size, i.e., the display ratio, of contents represented on the display unit 150. When a user plays a selected one of contents, the control unit 160 determines the display direction of the selected content by detecting output property information and then controls the display unit 150 to represent the selected content in the determined display direction. If an input signal to switch a display direction is received from the input unit 120, output property information in contents may support a change of a display direction. A user can therefore adjust the selected content to be displayed in a lengthwise mode or a widthwise mode on the display unit 150.

The broadcast receiving module 180, which is activated depending on an input signal received from the input unit 120, receives broadcast data from a broadcasting station or a broadcasting server and delivers it to the control unit 160. The broadcast receiving module 180 may extract broadcast additive information such as a program guide contained in broadcast data and, based on the extracted information, receive broadcast data of each channel.

Broadcast data received through the broadcast receiving module 180 may be outputted in a widthwise mode on the display unit 150 and may be switched to a lengthwise mode at a user's request. Additionally, broadcast data may be projected onto the external display screen through the projector module 140 under the control of the control unit 160. Here, the display direction of data displayed on the display unit 150 may determine at least one of the display direction and the display size of data projected through the projector module 140.

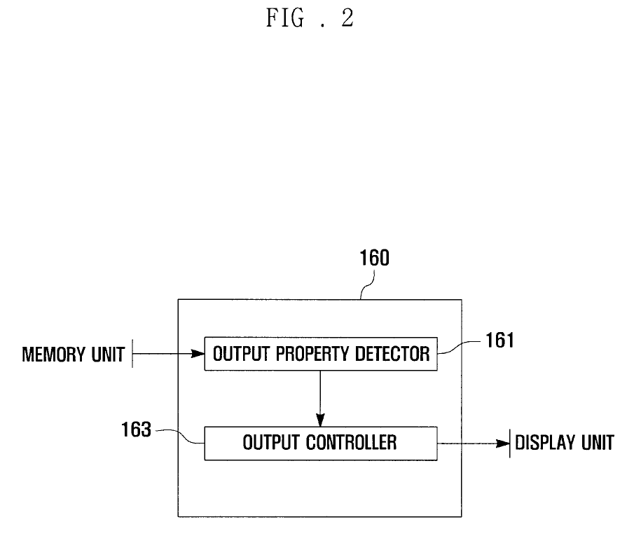

The control unit 160 supports an initialization procedure by controlling the power supply to each unit of the mobile device 100. After initialization, the control unit 160 may control signal flows between the respective units in order to support a projector control function when the projector module 140 is activated. Specifically, when receiving an input signal to activate the projector module 140 from the input unit 120, the control unit 160 loads a projector control application stored in the memory unit 170. Then, the control unit 160 controls the output properties of contents or applications being displayed or to be displayed on the display unit 150 according to activation of the projector control application. For the above, the control unit 160 which loads the projector control application may include an output property detector 161 and an output controller 163, as shown in FIG. 2.

The output property detector 161 is configured to detect the output properties of contents or applications selected depending on an input signal from the input unit 120. That is, when a user selects a specific one of contents stored in the memory unit 170, the output property detector 161 detects output property information which informs the display direction and the display size of the selected content to be displayed on the display unit 150. Then, the output property detector 161 sends the detected output property information to the output controller 163.

In addition, when a specific application such as a game application or a camera application is selected depending on a user's input, the output property detector 161 detects output property information which informs the display direction and the display size of the selected application to be displayed on the display unit 150. Then, the output property detector 161 sends the detected output property information to the output controller 163.

The output controller 163 is configured to control the display of the selected content or application, depending on output property information detected by the output property detector 161. If the detected output property information contains information on a lengthwise mode for example, the output controller 163 controls the display unit 150 to display the selected content or application in the form of a lengthwise page. Similarly, if the detected output property information contains information on a widthwise mode only, the output controller 163 controls the display unit 150 to display the selected content or application in the form of a widthwise page. On the other hand, if the detected output property information contains information on both a lengthwise mode and a widthwise mode, the output controller 163 controls the display unit 150 to display the selected content or application in a specific display direction predefined as default. Also, if a mode switch signal is inputted through the input unit 120, the output controller 163 controls the display unit 150 to switch a display direction.

Particularly, when a certain display image is being outputted on the display unit 150 in a specific display mode, the projector module 140 is activated and projects such a display image onto an external display screen. In this case, the output controller 163 of this invention may control the projector module 140 to output the display image according to the current display mode of the display unit 150.

Specifically, if some display image of specific content or application is being outputted on the display unit 150 in a lengthwise orientation, for example, the output controller 163 controls the projector module 140 to project that display image onto an external display screen in the form of a lengthwise page. Similarly, if a display image of specific content or application is being outputted on the display unit 150 in a widthwise orientation, the output controller 163 controls the projector module 140 to project that display image onto an external display screen in the form of a widthwise page.

Additionally, although the display unit 150 displays an output image in a lengthwise mode, for example, the output controller 163 may control the projector module 140 to project such an image in a widthwise mode depending on a mode switch signal from the input unit 120 in a case where output property information in the selected content or application contains information supporting a widthwise mode. Furthermore, although the display unit 150 remains in a lengthwise mode for example, the output controller 163 may control the projector module 140 to project a display image in a widthwise mode according to a user's setting environment or the supportability of the device. For this, the output controller 163 may include a function of regulating a display size and a function of switching a display direction.

In addition, when the display unit 150 displays an output image in the first display size, the output controller 163 may control the projector module 140 to project that output image in the second display size which is different from the first display size. For example, if the display unit 150 displays a certain image in a ratio of 4:3, the output controller 163 may control the projector module 140 to project that image in a ratio of 16:9. Besides, the output controller 163 may control the projector module 140 to project such images in various ratios depending on a user's setting environment or the supportability of the device.

As discussed heretofore, the mobile device having the projector module according to an embodiment of this invention may automatically regulate the display format, such as a display direction and a display size, of output images projected through the projector module, depending on the output properties of contents or applications. Additionally, the mobile device may automatically regulate the display format/orientation of output images projected through the projector module, depending on their display format on the display unit. Further, the mobile device may regulate the display format of output images projected through the projector module depending on mode switch signals from the input unit.

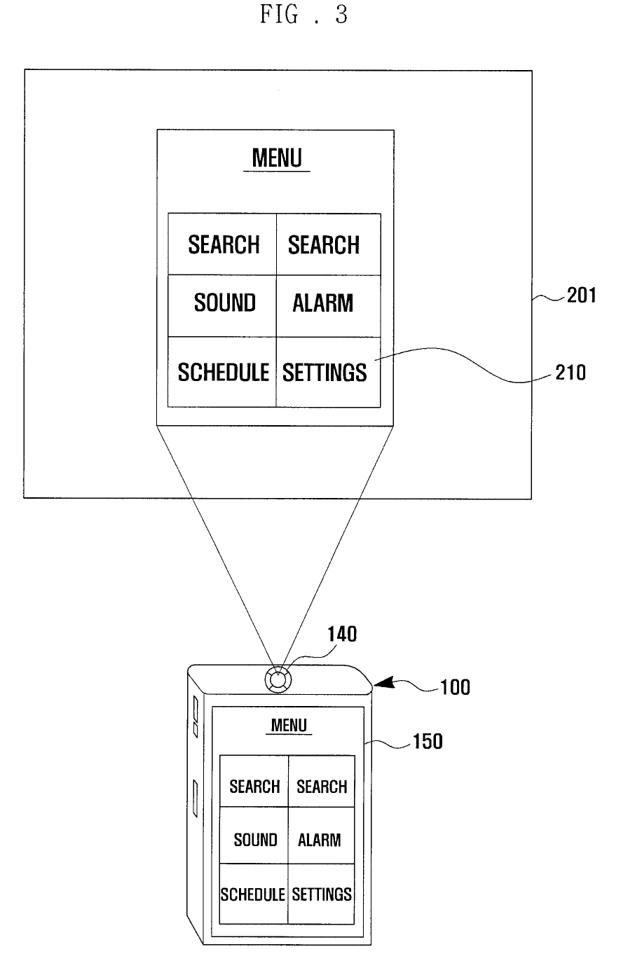

FIG. 3 is an example view which illustrates a display image projected onto an external display screen from a projector module in accordance with an exemplary embodiment of the present invention. FIG. 3 shows a case where output data to be projected is displayed on the display unit in a lengthwise mode.

Referring to FIG. 3, the mobile device 100 having the projector module 140 can output a menu page on the display unit 150 according to a user's selection. Specifically, when a user turns on the mobile device 100, an idle page is displayed on display unit 150. Then, if there is a user's input to select and activate a menu application, a corresponding menu page is displayed on the display unit 150. Here, the mobile device 100 detects output property information in the menu application and, if information on a lengthwise mode is provided, controls the menu page to be displayed in a lengthwise mode.

On the other hand, if there is a user's input to activate the projector module 140, the mobile device 100 controls the projector module 140 to project the menu page onto an external display screen 201, namely, in order that the menu page displayed on the display unit 150 is represented as the same menu page 210 on the external display screen 201. For the above, the mobile device 100 may offer a menu item or a hot key suitable for activation of the projector module 140.

Additionally, the mobile device 100 may regulate the display size of the menu page 210 projected on the external display screen 201. For example, if the display size of an output image on the display unit 150 is in a ratio of 4:3, a projected image on the external display screen 201 may be in the same ratio of 4:3 or in other ratio of 9:6 depending on a user's selection. In other words, the mobile device 100 may control a display image projected onto the external display screen 201 in the same ratio or in a changed ratio as the display size of an output image displayed on the display unit 150.

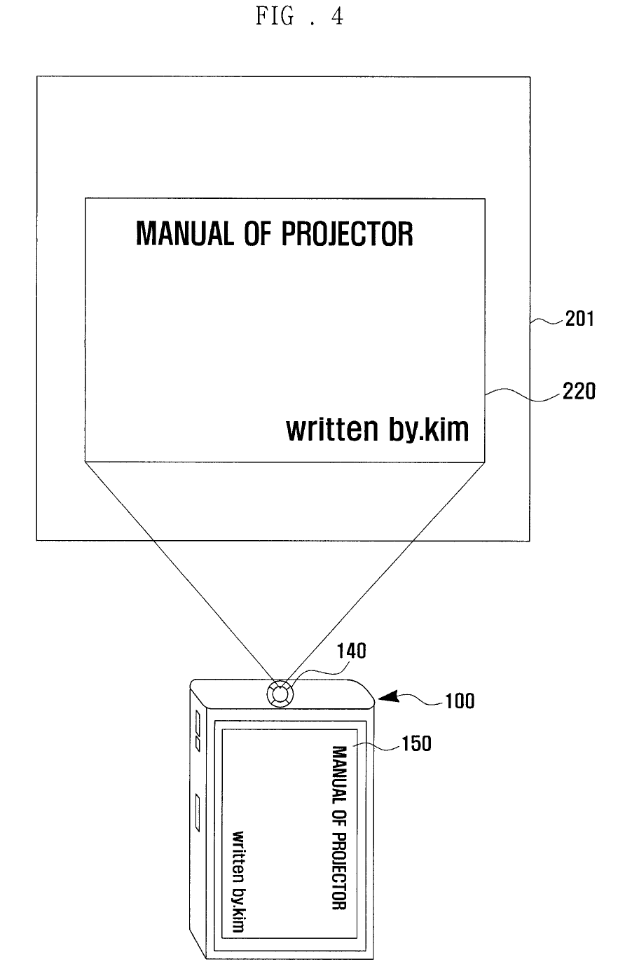

FIG. 4 is an example view which illustrates a display image projected onto an external display screen from a projector module in accordance with another exemplary embodiment of the present invention. FIG. 4 shows a case where output data to be projected is displayed on the display unit in a widthwise mode.

Referring to FIG. 4, the mobile device 100 can output a specific display page in association with the execution of a selected file on the display unit 150. Specifically, when a user turns on the mobile device 100, an idle page is displayed on display unit 150. Then, if there is a user's input to select and activate a particular one (e.g., a text file) of contents stored in the memory unit, a corresponding content page is displayed on the display unit 150. Here, the mobile device 100 detects output property information in the selected content and, if information on a widthwise mode is contained, controls the content page to be displayed in a widthwise mode.

If there is a user's input to activate the projector module 140, the mobile device 100 controls the projector module 140 to project the content page 220 of the selected content onto an external display screen 201, namely, in order that the content page displayed on the display unit 150 is represented as the same content page 220 on the external display screen 201. For the above, the mobile device 100 may offer a menu item or a hot key suitable for activation of the projector module 140.

Additionally, the mobile device 100 may regulate the display size of the content page 220 projected on the external display screen 201. For example, if the display size of an output image on the display unit 150 is in a ratio of 4:3, a projected image on the external display screen 201 may be in the same ratio of 4:3 or in other ratio of 16:9 depending on a user's selection. In other words, the mobile device 100 may control a display image projected onto the external display screen 201 in the same ratio or in a changed ratio as the display size of an output image displayed on the display unit 150.

On the other hand, the mobile device 100 may change the display format of an output image projected onto the external display screen 201, depending on a user's input. For example, if there is a user's input for a mode switch while the menu page 210 is displayed on the external display screen 201 in a lengthwise mode as shown in FIG. 3, the mobile device 100 changes the display mode of the menu page 210 on the external display screen 201 to a widthwise mode. Here, the menu page displayed on the display unit 150 may remain in a lengthwise mode without a change of the display mode or may follow a change of the display mode.

Additionally, if there is a user's input for a mode switch while the content page 220 is displayed on the external display screen 201 in a widthwise mode as shown in FIG. 4, the mobile device 100 changes the display mode of the content page 220 on the external display screen 201 to a lengthwise mode. Here, the menu page displayed on the display unit 150 may remain in a widthwise mode without a change of the display mode or may follow a change of the display mode. Such a change in the display mode in the display unit 150 may depend on a user's setting environment.

Although the above description referring to FIGS. 3 and 4 uses the menu page and the content page for example, the present invention is not limited thereto. A function to control the projector module in this invention may be favorably applied to any other various display images in association with the operation of the RF unit, the operation of the broadcast receiving module, a search for contents, the execution of a game application, the activation of a camera module, the use of a message service, and so forth.

Specifically, when a user activates the projector module during a video call through the RF unit, the projector module may project transmitting and receiving images onto an external display screen under the control of the control unit. In addition to a normal projection screen, a wall or any other types of objects on which a picture is projected for viewing may be alternatively used as an external display screen for the present invention. As discussed above, the mobile device may output display images transmitted and received through the RF unit in a lengthwise mode on the display unit, and also, may output them in a widthwise mode or a given wide display ratio through the projector module.

In a case of game applications, the mobile device may control the projector module to project images in a widthwise orientation or in a lengthwise orientation according to game types. For this, each individual game application may be preset with a preferred orientation that would yield an optimum viewing experience to a user during a play mode. Alternatively, when game images are projected through the projector module, the mobile device may follow a user's preference. That is, the mobile device may control the projector module to project game images in a specific display format which is preset or selected by a user. To support this, the mobile device may have menu options for environment settings of the projector module so that a user can set the projector module environment in a setting mode.

The mobile device may offer projected images in different display modes according to picture-taking directions even the same picture. That is, a picture taken in a lengthwise direction may be projected in a lengthwise mode through the projector module, and a picture taken in a widthwise direction may be projected in a widthwise mode through the projector module. Here, the display unit of the mobile device may output all pictures in a lengthwise mode only or in a widthwise mode only regardless of picture types. In a case of playing a video file, although the display unit outputs such a video file in a lengthwise mode for example, the projector module may project that video file in a widthwise mode. Also, depending on a predetermined value or a user's setting environment, such as a user's preference, the display ratio of a video file projected through the projector module may be equal to or different from the display ratio of that video file displayed on the display unit.

On the other hand, although the display direction of output images projected through the projector module may depend generally on the output properties of such images displayed on the display unit, the present invention is not limited thereto. Although the display unit displays some image in a lengthwise mode for example, the projector module may project such an image in a widthwise mode when output property information in related contents or applications is set to a widthwise mode or a wide mode.

In addition, although the display format of output images projected through the projector module may depend generally on output property information in contents or application, the present invention is limited thereto. In some embodiment, the display format may depend to only output property information in applications regardless of output property information in contents. That is, in a projector control application, the mobile device may define output property information based on applications for the activation of contents such as pictures or text files. Then, the mobile device may regulate a display format of each of contents depending on the defined output property information.

If output property information in contents conflicts with output property information in applications, the mobile device may follow a user's setting environment. That is, in order to regulate output images projected through the projector module, the mobile device may detect output property information in one or the other of content and application.

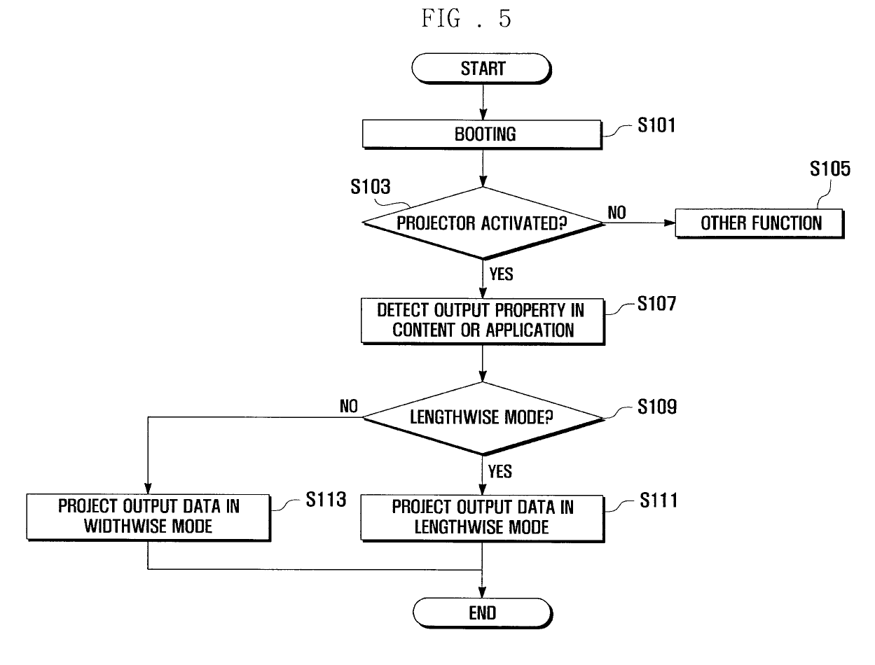

FIG. 5 is a flow diagram which illustrates a display method for data projected onto an external display screen from a projector module in accordance with an exemplary embodiment of the present invention.

Referring to FIG. 5, at the outset, the mobile device completes the booting by initializing each element thereof (step S101). After the booting, the mobile device may output a predefined idle page on the display unit.

Next, the mobile device determines whether a projector function is activated (step S103). That is, the mobile device ascertains whether there is a selection of a specific menu item or a predefined hot key for activating the projector module. If there is no selection for the activation of the projector module in the step S103, the mobile device may perform other available function such as a file search function, a call function, a camera function, a game function, etc. according to a user's selection (step S105).

If receiving an input for activating the projector module in the step S103, the mobile device detects output property information in a user's selected content or application (step S107). Here, the mobile device may output on the display unit a selection page which allows a user to select contents or applications.

Then, the mobile device determines whether the detected output property information is a lengthwise mode (step S109). In a case of a lengthwise mode as the result of determination in the step S109, the mobile device controls the projector module to project output data of the selected content or application in a lengthwise mode (step S111). In a case of a widthwise mode as the result of determination in the step S109, the mobile device controls the projector module to project output data of the selected content or application in a widthwise mode (step S113).

Additionally, the mobile device may regulate the display size or ratio of output data according to a predetermined value or a user's setting environment. That is, when projecting output data in a widthwise mode for example, the mobile device may maintain the display ratio of output images displayed on the display unit or may change it to other ratio such as a wide form. Similarly, when projecting output data in a lengthwise mode, the mobile device may maintain the display ratio of output images displayed on the display unit or may change it to other ratio.

On the other hand, the mobile device may activate a specific application required for the execution of selected content. In this case, if output property information in the executed content conflicts with output property information in the activated application, the mobile device may follow particular output property information according to a user's setting environment or a device presetting environment. For example, if a user selects a music file among contents, the mobile device may activate an application corresponding to a media player for a music file. Here, let's suppose that the output property of a music file is a lengthwise mode and that of a media player is a widthwise mode. In this case, the mobile device may control the projector module to project music content data in a widthwise mode according to the output property of a media player. Alternatively, the mobile device may follow the output property of a music file depending on a user's setting environment or a device presetting environment. Also, the mobile device may use different display formats for the display unit and the projector module. That is, the mobile device may output a display image in a lengthwise mode on the display unit and project such a display image in a widthwise mode through the projector module.

As discussed heretofore, the display method of the present invention may control the projector module to project a display image in a lengthwise mode or a widthwise mode according to output property information defined in at least one of contents and applications, and also, may regulate a display ratio according to a user's setting environment or a device presetting environment. Accordingly, the mobile device of the present invention may enhance user's convenience in connection with the projector module.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A method for displaying data in a mobile device having a projector module, the method comprising:
activating the projector module;
detecting output property information in at least one of content and an application;
determining a display format of output data of the content or the application based on the detected output property information; and
selectively projecting the output data in the determined display format through the activated projector module.

2. The method of claim 1, wherein the projecting of the output data includes:
projecting the output data in a lengthwise orientation if the determined display format is a lengthwise mode;; and
projecting the output data in a widthwise orientation if the determined display format is a widthwise mode.

3. The method of claim 2, further comprising:
receiving an input signal for a mode switch;
changing the lengthwise mode to the widthwise mode if a display direction of the output data is the lengthwise mode; and
changing the widthwise mode to the lengthwise mode if the display direction of the output data is the widthwise mode.

4. The method of claim 2, further comprising:
receiving an input signal for a size adjustment; and
regulating a display ratio of the output data based on a predetermined value or a user's preference.

5. The method of claim 1, wherein the detecting of the output property information includes one of:
detecting the output property information only in the application regardless of the output property information in the content; and
detecting the output property information only in the content regardless of the output property information in the application.

6. The method of claim 1, wherein the detecting of the output property information includes:
if the output property information in the content conflicts with the output property information in the application, detecting the output property information in only one of the content and the application according to a user's setting environment or a device presetting environment.

7. The method of claim 1, further comprising:
displaying the output data in a lengthwise orientation on a display unit,
wherein the projecting of the output data includes projecting the output data in a widthwise orientation if the display format has a widthwise mode as the display direction.

8. The method of claim 1, wherein an orientation of the output data projected through the activated projector module is different from a display orientation in a screen of the mobile device.

9. A mobile device comprising:
a memory unit configured to store at least one content or at least one application;
a display unit configured to display output data related to the execution of the content or the application stored in the memory unit;
a control unit configured to detect output property information in at least one of the content and the application and to determine a display format of the output data of the content or the application based on the detected output property information; and
a projector module configured to project the output data in the determined display format under the control of the control unit.

10. The mobile device of claim 9, wherein the control unit is further configured to control the projector module to project the output data in a lengthwise orientation if the display format has a lengthwise mode as a display direction and a widthwise orientation if the display format has a widthwise mode as the display direction.

11. The mobile device of claim 10, further comprising:
an input unit configured to create at least one of an input signal for a mode switch between the lengthwise mode and the widthwise mode and configured to regulate a display ratio of the output data.

12. The mobile device of claim 9, wherein the control unit is further configured to detect the output property information only in the application regardless of the output property information in the content, or only in the content regardless of the output property information in the application.

13. The mobile device of claim 9, wherein the control unit is further configured to, if the output property information in the content conflicts with the output property information in the application, detect the output property information in only one of the content and the application according to a user's preference or a device presetting environment.

14. The mobile device of claim 9, wherein the control unit is further configured to control the display unit to display the output data in a lengthwise mode, and to control the projector module to project the output data in a widthwise mode if the display format has a widthwise mode as the display direction.

15. The method of claim 1, wherein an orientation of the output data projected through the activated projector module is different from the display orientation in a screen of the mobile device.
